(19) United States
(12) Patent Application Publication
(10) Pub. No.: US 2026/0127410 A1
(43) Pub. Date: May 7, 2026

(54) MATERIAL PROPERTY PREDICTION SYSTEM AND METHOD

(71) Applicant: LG MANAGEMENT DEVELOPMENT INSTITUTE CO., LTD., Seoul (KR)

(72) Inventors: Changyoung PARK, Seoul (KR); Jaewan LEE, Seoul (KR); Munjal MRIGI, Seoul (KR); Hongjun YANG, Seoul (KR); Sehui HAN, Seoul (KR)

(21) Appl. No.: 19/437,173

(22) Filed: Dec. 30, 2025

Related U.S. Application Data
(63) Continuation of application No. PCT/KR2025/008235, filed on Jun. 16, 2025.

(30) Foreign Application Priority Data
Sep. 5, 2024 (KR) 10-2024-0120761
Mar. 24, 2025 (KR) 10-2025-0037485
Mar. 24, 2025 (KR) 10-2025-0037494

(51) Int. Cl. G06N 3/045; G06N 3/096

(52) U.S. Cl. CPC G06N 3/045; G06N 3/096

(57) ABSTRACT

A system for predicting a property of a material of the present invention may extract a graph embedding by inputting material information into a first artificial intelligence (AI) model, and extract a text embedding by inputting a text description of a crystal structure of the material into a second AI model, classify the text embedding into a plurality of structure information embeddings, and concatenate the graph embedding with at least one of the plurality of structure information embeddings, wherein the structure information embeddings may be classified to include global information, semi-global information, and local information of the crystal structure. The provided system and method may be employed to predict aspects of a crystal structure, a molecular structure, a protein structure, a catalyst structure, or a metal-organic framework of a target material, or to predict physical properties of a target material.

### CROSS REFERENCE TO RELATED APPLICATIONS

This application is a Bypass Continuation of International Patent Application No. PCT/KR2025/008235, filed on Jun. 16, 2025, which claims priority from and the benefit of Korean Patent Application No. 10-2024-0120761, filed on Sep. 5, 2024, Korean Patent Application No. 10-2025-0037485, filed on Mar. 24, 2025, and Korean Patent Application No. 10-2025-0037494, filed on Mar. 24, 2025, each of which is hereby incorporated by reference for all purposes as if fully set forth herein.

### BACKGROUND

### Field

Embodiments of the invention relate generally to a material property prediction system and method, and, more particularly, to a material property prediction system and prediction method capable of predicting a property of a material by using a graph-based model and a text-based model.

### Discussion of the Background

Recently, artificial intelligence (AI) technology has shown advanced development and is attracting attention across society. AI refers to the execution by a computer of intellectual abilities unique to humans at a high level of capability, such as “a computer brain that performs domains achievable by human intelligence,” “engineering and science for making intelligent machines,” “a set of algorithms designed to think, perceive, and act like a human,” and the like.

AI is introduced as providing a highly integrated smart space in combination with augmented reality, Internet of Things, edge computing, and digital twin, and the like and is emphasized as a core new technology leading the era of the Fourth Industrial Revolution. In addition, AI is drawing attention as a next-generation growth engine that can evolve the industrial ecosystem beyond standardized problem-solving, and is actively applied not only to IT, medical care, agriculture, energy, automobiles, and robots, but also to knowledge service industries such as distribution, finance, law, education, real estate, advertising, and communication. That is, AI is preparing for a new era by being combined with all existing systems ranging from industries aimed at improving convenience or quality of life to overall cultural and artistic aspects of our society.

As product development methods have recently diversified, the development of new materials usable in product manufacturing has been actively conducted. Such materials greatly affect characteristics of products, and properties of a material sometimes become a determining factor for characteristics of a manufactured product. Therefore, in order to more efficiently develop and mass-produce a material used in product manufacturing, predicting and analyzing the property of the material may be essential.

Traditionally, to check characteristics of the manufactured product according to the characteristics of the material, a method in which various materials are developed, the characteristics of each material are checked, and then the material is test-applied to a final product to check characteristics of the final product has been used. However, the conventional method requires significant cost and time for the development of materials and the characteristics of the materials, and also has a problem that it is difficult to find a material having optimal characteristics.

To improve such a traditional method, research on methods for predicting a property of a material using AI has been actively conducted. Related art includes Korean Patent Publication No. 10-2024-0011349 (Jan. 26, 2024).

The above information disclosed in this Background section is only for understanding of the background of the inventive concepts, and, therefore, it may contain information that does not constitute prior art.

### SUMMARY

One embodiment of the present invention is directed to providing a material property prediction system and prediction method capable of predicting a property of a material by combining a graph-based structural embedding related to the property of the material and a text embedding related to the property of the material derived from a language model.

One embodiment of the present invention is directed to providing a material property prediction system and prediction method capable of predicting a property of a material by performing Cross-Attention between a graph-based structural embedding related to the property of the material and a text embedding related to the property of the material derived from a language model.

Additional features of the inventive concepts will be set forth in the description which follows, and in part will be apparent from the description, or may be learned by practice of the inventive concepts.

A system for predicting a property of a material of one embodiment of the present invention may include at least one processor, and at least one memory storing an instruction or information executed by the at least one processor, wherein an operation performed by the instruction or information executed by the at least one processor may comprise an operation of extracting a graph embedding by inputting information relating to a material into a first artificial intelligence (AI) model, an operation of extracting a text embedding by inputting a text description of a crystal structure of the material into a second AI model, an operation of classifying the text embedding into a plurality of structure information embeddings, an operation of concatenating the graph embedding with at least one of the plurality of structure information embeddings, wherein the structure information embeddings may be classified to include global information, semi-global information, and local information of the crystal structure, and an operation of determining details of at least one aspect of a crystal structure, a molecular structure, a protein structure, a catalyst structure, or a metal-organic framework (MOF) for the material, or a numerical representation for at least one physical property of the material, based on results of the concatenating operation.

Here, the first AI model may include an embedding layer encoding a graph node for an atom of the crystal structure in the material information and connection information between the atoms, and an interaction layer repeatedly refining a representation of the material based on the graph node and the connection information.

The global information may include comprehensive arrangement information of the crystal structure including a mineral type, a space group, a dimensionality, and a symmetry property, the semi-global information may include atomic arrangement information in the crystal structure including geometry and connectivity in the crystal structure, and the local information may include atomic-level detailed information in the crystal structure including a type of the atom and a bond length between the atoms in the crystal structure.

The graph embedding may be projected into a 128-dimensional vector through a first projection head of the first AI model, and the text embedding may be projected into a 128-dimensional vector through a second projection head of the second AI model, and the graph embedding and the text embedding may be concatenated in a concatenate layer to generate a multimodal embedding.

The multimodal embedding may be input into a fully connected layer to predict a property of a target material.

The graph embedding may be concatenated with the text embedding including at least the semi-global information.

The graph embedding may be concatenated with the text embedding including the global information and the semi-global information.

A computerized method for predicting a property of a material of one embodiment of the present invention may include extracting a graph embedding by inputting information relating to a target material into a first artificial intelligence (AI) model executed by a processor, extracting a text embedding by inputting a text description of a crystal structure of the target material into a second AI model executed by the processor, classifying the text embedding into a plurality of structure information embeddings by the processor, concatenating the graph embedding with at least one of the plurality of structure information embeddings by the processor, wherein the structure information embeddings may be classified to include global information, semi-global information, and local information of the crystal structure; and predicting details of at least one aspect of a crystal structure, a molecular structure, a protein structure, a catalyst structure, or a metal-organic framework (MOF) for the target material, or a numerical representation for at least one physical property of the target material, based on results of the concatenating operation.

Here, in the extracting of the graph embedding, the material information input into the first AI model may be encoded in an embedding layer as a graph node for an atom of a crystal structure in the material information and connection information between the atoms, and a representation of the material may be repeatedly refined in an interaction layer based on the graph node and the connection information.

The global information may include comprehensive arrangement information of the crystal structure including a mineral type, a space group, a dimensionality, and a symmetry property, the semi-global information may include atomic arrangement information in the crystal structure including geometry and connectivity in the crystal structure, and the local information may include atomic-level detailed information in the crystal structure including a type of the atom and a bond length between the atoms in the crystal structure.

Before the concatenating, the graph embedding may be projected into a 128-dimensional vector through a first projection head of the first AI model, and the text embedding may be projected into a 128-dimensional vector through a second projection head of the second AI model, and in the concatenating, the projected graph embedding and the projected text embedding may be concatenated in a concatenate layer to generate a multimodal embedding. The predicting step of the method may further include predicting a property of a target material, wherein the predicting of the property may include inputting the multimodal embedding into a fully connected layer to predict the property of the target material.

In the concatenating step of the method, the graph embedding may be concatenated with the text embedding including at least the semi-global information.

In the concatenating step of the method, the graph embedding may be concatenated with the text embedding including the global information and the semi-global information.

The target material may be a cathode material for a secondary battery, and the predicting step of the method may predict a shear modulus, a bulk modulus, or a bandgap of the target material.

The target cathode material may include at least 60% manganese by weight.

An application specific integrated circuit (ASIC) to which one embodiment of the present invention is applied may include a functional block including a non-transitory memory storing information and an instruction and at least one processor requesting access to the memory, wherein the memory may store an instruction or information for extracting a graph embedding by inputting information relating to a target material into a first artificial intelligence (AI) model, extracting a text embedding by inputting a text description of a crystal structure of the target material into a second AI model, classifying the text embedding into a plurality of structure information embeddings, and concatenating the graph embedding with at least one of the plurality of structure information embeddings, wherein the structure information embeddings may be classified to include global information, semi-global information, and local information of the crystal structure, and wherein the memory may store a further instruction or information for generating a predicted numerical value for at least one physical property for the target material based on a result of the concatenating.

A system for predicting a property of a material of one embodiment of the present invention may include at least one processor, and at least one memory storing an instruction or information executed by the at least one processor, wherein an operation performed by the instruction or information executed by the at least one processor may include an operation of extracting a graph embedding by inputting information relating to a target material into a first artificial intelligence (AI) model, an operation of extracting a text embedding by inputting a text description of a crystal structure of the target material into a second AI model, an operation of performing cross-attention on the graph embedding and the text embedding, and an operation of predicting a numerical value for at least one physical property for the target material based on a result of the cross-attention operation.

Here, the first AI model may include an embedding layer encoding a graph node for an atom of the crystal structure in the target material information and connection information between the atoms, and an interaction layer repeatedly refining a representation of the target material based on the graph node and the connection information.

The text embedding may include comprehensive arrangement information of the crystal structure of the target material, atomic arrangement geometry information in the crystal structure, and atomic-level detailed information in the crystal structure, wherein the comprehensive arrangement information may include a mineral type, a space group, a dimensionality, and a symmetry property, the atomic arrangement geometry information may include geometry and connectivity in the crystal structure, and the atomic-level detailed information may include a type of the atom and a bond length between the atoms in the crystal structure.

The cross-attention may set the graph embedding as a query and set the text embedding as a key and a value to predict the query.

The operation performed by the instruction or the information may further include an operation of fine tuning the second AI model.

The fine tuning may be performed by a Low-Rank Adaptation (LoRA) method that freezes weights of the second AI model and reduces the number of trainable parameters.

A computerized method for predicting a property of a material of one embodiment of the present invention may include extracting a graph embedding by inputting information relating to a target material into a first artificial intelligence (AI) model executed by a processor, extracting a text embedding by inputting a text description of a crystal structure of the material into a second AI model executed by the processor, performing cross-attention on the graph embedding and the text embedding by the processor, and predicting a numerical value for at least one physical property for the target material based on a result of the performing step.

Here, in the extracting of the graph embedding, the material information input into the first AI model may be encoded in an embedding layer as a graph node for an atom of a crystal structure in the material information and connection information between the atoms, and a representation of the material may be repeatedly refined in an interaction layer based on the graph node and the connection information.

The text embedding may include comprehensive arrangement information of the crystal structure of the material, atomic arrangement geometry information in the crystal structure, and atomic-level detailed information in the crystal structure, wherein the comprehensive arrangement information may include a mineral type, a space group, a dimensionality, and a symmetry property, the atomic arrangement geometry information may include geometry and connectivity in the crystal structure, and the atomic-level detailed information may include a type of the atom and a bond length between the atoms in the crystal structure.

In the performing of the cross-attention, the graph embedding may be set as a query and the text embedding may be set as a key and a value such that the query may refer to the key and the value to predict the query.

A material property prediction method may further include fine tuning the second AI model.

In the fine tuning of the second AI model, the fine tuning may be performed by a Low-Rank Adaptation (LoRA) method that freezes weights of the second AI model and reduces the number of trainable parameters.

The target material may be a cathode material for a secondary battery, and the physical property predicted may be a shear modulus, a bulk modulus, or a bandgap of the target material.

The target cathode material may include at least 60% manganese by weight.

An application specific integrated circuit (ASIC) of one embodiment of the present invention may include a functional block including a non-transitory memory storing information and an instruction and at least one processor requesting access to the memory, wherein the memory may store an instruction or information including operations of extracting a graph embedding by inputting material information into a first artificial intelligence (AI) model, extracting a text embedding by inputting a text description of a crystal structure of the material into a second AI model, performing cross-attention between the graph embedding and the text embedding, fine tuning the second AI model, and predicting a property of a target material by inputting target material information into the first AI model.

According to one embodiment of the present invention, prediction performance of a property of a new material can be improved by combining a graph-based structural embedding and a text embedding related to the property of the material for predicting the property of the new material.

According to one embodiment of the present invention, prediction performance of a property of a new material can be improved by performing Cross-Attention between a graph-based structural embedding and a text embedding related to the property of the material for predicting the property of the new material.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a schematic diagram of an electronic device according to one embodiment of the present invention.

FIG. 2 is a schematic diagram showing a material property prediction method according to one embodiment of the present invention.

FIG. 3 is a schematic diagram showing a text description of a crystal structure of a material according to one embodiment of the present invention.

FIG. 4 is a schematic diagram showing a learning model according to one embodiment of the present invention.

FIG. 5 is a schematic diagram showing a material property prediction method according to another embodiment of the present invention.

FIG. 6 is a schematic diagram showing a pre-trained model according to another embodiment of the present invention.

FIG. 7 is a schematic diagram showing a property prediction model according to another embodiment of the present invention.

### DETAILED DESCRIPTION

The present disclosure meets a need in the art by applying machine learning to the task of predicting structural and physical properties of target materials in a new way.

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

In order to clarify the technical spirit of the present disclosure, embodiments of the present invention will be described in detail with reference to the accompanying drawings. In describing the present disclosure, when it is determined that the detailed description of a related known function or component may unnecessarily obscure the gist of the present disclosure, the detailed description thereof will be omitted. In the drawings, components having substantially the same function or configuration are given the same reference numerals and symbols as possible even when they are shown in different drawings. For convenience of explanation, an apparatus and method will be described together when necessary. Each operation of the present disclosure does not necessarily need to be performed in the order described, and may be performed in parallel, selectively, or individually.

Terms used in the embodiments of the present disclosure were selected as general terms widely used at present as possible while considering functions of the present disclosure, but these terms may vary depending on the intention of those skilled in the art, legal precedents, the emergence of new technologies, or the like. In addition, in specific cases, there are terms arbitrarily selected by the applicant, and in this case, the meanings thereof will be described in detail in the description of the corresponding embodiment. Therefore, terms used in the present specification should be defined based on the meanings of the terms and the overall contents of the present disclosure rather than just the names of the terms.

Throughout the present disclosure, singular expressions may include plural expressions unless the context explicitly states otherwise. It should be understood that terms such as “comprise” or “have” are intended to specify the presence of a feature, number, step, operation, component, part, or a combination thereof, but do not preemptively preclude the possibility of the presence or addition of one or more other features, numbers, steps, operations, components, parts, or combinations thereof. That is, throughout the present disclosure, when a certain portion is described as “including,” a certain component, it means further including another component rather than precluding another component unless especially stated otherwise.

Expressions such as “at least one” modify the entire list of components, and do not individually modify components of the list. For example, “at least one of A, B, and C” or “at least one of A, B, or C” refers to only A, only B, only C, both A and B, both B and C, both A and C, all of A, B, and C, or a combination thereof.

In addition, terms such as “ . . . unit,” “ . . . module”, etc. described in the present disclosure mean a unit that process at least one function or operation, which may be implemented as hardware or software, or a combination of hardware and software.

Throughout the present disclosure, when a certain portion is described as being “connected” to another portion, it includes not only a case where the certain portion is “directly connected” to another portion, but also a case where the certain portion is “electrically connected” to another portion with another element interposed therebetween. In addition, when a certain portion is described as “including” a certain component, it means further including another component rather than precluding another component unless specifically stated otherwise.

The expression “configured to (or set to)” as used throughout the present disclosure may, depending on the contexts, be used interchangeably with, for example, “suitable for,” “having the capacity to,” “designed to,” “adapted to,” “made to,” or “capable of.” The term “configured to (or set to)” does not necessarily mean only “specifically designed to” in hardware. Instead, in certain contexts, the expression “a system configured to” may mean that the system is “capable of” in conjunction with other devices or parts. For example, the phrase “a processor configured to (or set to) perform A, B, and C” may mean a dedicated processor (e.g., an embedded processor) for performing corresponding operations, or a generic-purpose processor (e.g., a CPU or application processor) that can perform corresponding operations by executing one or more software programs stored in memory.

Artificial intelligence (AI) is a field of computer engineering and information technology that studies methods for enabling a computer to perform thinking, learning, and self-development that can be performed by human intelligence, and refers to enabling a computer to imitate intelligent behavior of a human. In addition, AI does not exist by itself, but is directly or indirectly related to many other fields of computer science. In particular, in modern times, attempts to introduce artificial intelligence elements into various fields of information technology and utilize the artificial intelligence elements to solve problems in those fields are being very actively made.

Machine learning is a field of AI and is a study that provides the ability for a computer to learn without explicit programming. Specifically, machine learning may be described as a technology for studying and constructing systems that learn, perform prediction, and improve their own performance based on empirical data, and algorithms therefor. Algorithms of machine learning do not execute strictly predetermined static program instructions, but rather adopt an approach of constructing a specific model to derive a prediction or decision based on input data. The term “machine learning” may be used interchangeably with the term “mechanical learning.”

With respect to how to classify data in machine learning, a variety of machine learning algorithms have been developed. Representative examples include decision trees, Bayesian networks, support vector machines (SVM), and artificial neural networks (ANNs). The decision tree is an analytical method that performs classification and prediction by visualizing decision rules in a tree structure. A Bayesian network is a model that represents probabilistic relationships (conditional independence) among multiple variables in a graph structure. The Bayesian network is suitable for data mining through unsupervised learning. The SVM is a model of supervised learning for pattern recognition and data analysis, and is mainly used for classification and regression. The ANN models the operating principle of biological neurons and the connection relationship between neurons, and is an information processing system in which multiple neurons, referred to as nodes or processing elements, are connected in the form of a layer structure.

The ANN is a model used in machine learning and may be described as a statistical learning algorithm inspired by neural networks (particularly the brain in the central nervous system of animals) in biology in machine learning and cognitive science. Specifically, the ANN may refer to an overall model in which artificial neurons (nodes) forming a network through synaptic connections change synaptic connection strengths through training, thereby having a problem-solving capability. The ANN may be used interchangeably with the term, Neural Network.

The ANN may include a plurality of layers, and each of the layers may include a plurality of neurons. In addition, the ANN may include synapses connecting neurons to neurons. The ANN may generally be defined by the following three factors: (a) a connection pattern between neurons of different layers, (b) a training process of updating a weight of the connection, and (c) an activation function generating an output value from a weighted sum of inputs received from a previous layer.

The ANN may include network models such as a deep neural network (DNN), a recurrent neural network (RNN), a bidirectional recurrent deep neural network (BRDNN), a multilayer perceptron (MLP), and a convolutional neural network (CNN), but is not limited thereto. In the present specification, the term “layer” may be used interchangeably with the term “hierarchy.”

The ANN is classified into single-layer neural networks and multi-layer neural networks according to the number of hierarchies. A general single-layer neural network includes an input layer and an output layer. In addition, a general multi-layer neural network includes an input layer, one or more hidden layers, and an output layer.

The input layer is a layer that receives external data, and the number of neurons in the input layer is the same as the number of input variables, and the hidden layer is located between the input layer and the output layer, receives a signal from the input layer, extracts a feature, and transfers the feature to the output layer. The output layer receives a signal from the hidden layer and outputs an output value based on the received signal. An input signal between neurons is multiplied by each connection strength (weight) and then summed, and when the sum is greater than a threshold of a neuron, the neuron is activated and outputs an output value obtained through an activation function.

Meanwhile, the DNN including a plurality of hidden layers between an input layer and an output layer may be a representative ANN implementing deep learning, which is a type of machine learning technology. Meanwhile, the term “deep learning” may be used interchangeably with the term “deep architecture learning,” and the term “learning” may be used interchangeably with “training.”

A workflow of machine learning includes a series of processes of collecting data for training and validation, modeling, and then training a model, and may include processes of collecting training data, inspecting and exploring data, preprocessing and cleaning data, and modeling and training.

### 1. Collecting Training Data

Training data applied to training of a learning model of the present specification may be generated using data collected from numerous samples. In the present specification, at least one different types of training data sets may be used to train the learning model, and each training data may further include one or more experiment-based results used as function labels. At least some of the training data sets may be used to train the learning model, and some others may be used to validate the trained learning model.

The data used in a graph model of one embodiment of the present invention may have a Simplified Molecular-Input Line-Entry System (SMILES) format, which is generally used to represent a chemical formula of a molecule as a string. The SMILES is a notation that represents a molecular structure in the form of a string, thereby enabling the molecular structure to be applied to various machine learning and deep learning algorithms. In general, the SMILES may include an atom, a bond, a ring, an aromaticity, and a branch. In SMILES notation, each atom is represented by the corresponding element symbol. For example, carbon may be represented as C, nitrogen as N, oxygen as O, and chlorine as Cl, and hydrogen atoms H may be omitted. The bond is represented by eight symbols “.”, “−”, “=”, “#”, “$”, “:”, “/”, and, “\”. For example, a double bond may be represented as “=”, a triple bond as “#”, and a quadruple bond as “$”. The ring is represented in a manner of breaking a bond at an arbitrary point in the molecular structure and marking two atoms at the corresponding broken portion with numbers. The aromaticity refers to containing an aromatic ring in which a carbon compound is bonded in the form of a planar ring to have a stable structure, and the aromatic ring is represented in the same manner as the above-described ring, but atoms B, C, N, O, P, and S included therein are marked in lowercase letters. The branch of a molecule is represented by parentheses. The first atom included in the parentheses and the first atom appearing after the closing parenthesis may be connected to the same atom. Since the same molecular structure may have different SMILES representations, ambiguity may occur. To resolve such ambiguity, tools such as an RDKit library may be utilized. By removing duplicate compounds and unclear structural formats in a collected data set, the data set for graphing of molecules may be finally obtained. Such a data set of SMILES representations may be represented as an adjacency matrix or an adjacency list in order to be expressed in a graph format with nodes and edges. The adjacency matrix and adjacency list represent connection relationships of a graph in a two-dimensional array and a list, respectively.

The data used in a text embedding of one embodiment of the present invention may include a text description of a crystal structure. In one embodiment, text description data may be obtained through a Robocrystallographer package that generates a text description in a manner similar to that in which an actual crystallographer analyzes a structure. When generating a text description of a crystal structure, the Robocrystallographer package indicates symmetry, a local environment, and extended connectivity, and such a package may include utilities for identifying molecule names, component orientation, heterostructure information, and the like. For example, the Robocrystallographer package used in one embodiment, when SnO₂ is given as input, may output a text such as: “SnO₂ is Rutile structured and crystallizes in the tetragonal P4_2/mnm space group. The structure is three-dimensional. Sn(1) is bonded to six equivalent O(1) atoms to form a mixture of edge and corner-sharing SnO₆ octahedra. The corner-sharing octahedral tilt angles are 51°. All Sn(1)-O(1) bond lengths are 2.09 Å. O(1) is bonded in a trigonal planar geometry to three equivalent Sn (1) atoms.” Such a text description may include extensive information including global characteristics (e.g., a space group and a crystal type), local detailed information (e.g., a bond length and a coordination environment), and semi-global characteristics (e.g., connectivity and a structural arrangement).

### 2. Inspecting and Exploring Data

Once the training data for training the learning model is collected, the collected training data may undergo inspection and exploration regarding a data structure, noise data, and a data cleaning method for applying machine learning.

Such a stage of inspecting and exploring data is referred to as an exploratory data analysis (EDA) stage, and the EDA may be described as a process of observing and understanding the collected data from various perspectives. Before training the data, independent variables, dependent variables, types of variables, data types of variables, and the like may be inspected through visualization such as graphs, statistical tests, and the like, and features of the data and inherent structural relationships can be confirmed in advance. Through such an EDA, by examining a distribution and values of data, phenomena represented by the data may be better understood, and potential problems in the data may be discovered. In addition, through a process of inspecting data from various perspectives, various patterns that may not have been identified at a problem definition stage may be discovered, and, based on this, existing hypotheses may be modified or new hypotheses may be established. Exploratory data analysis may broadly include a process of exploring abnormal values in the data and a process of analyzing relationships among data attributes.

The process of exploring abnormal values is to check whether outliers exist in the data, and may include a sampling method, a statistical method, and a visualization method. The sampling method extracts a random sample from data to check an overall trend and peculiarities of data values. The statistical method may use summary statistics such as a mean, a median, and a mode for checking a center of data, or a range and a variance for checking a dispersion of data. The visualization method may determine which statistical indicators are appropriate for individual attributes of the collected data by utilizing a probability density function, a histogram, a dotplot, a word cloud, a time series chart, a map, and the like. However, when using statistical indicators, it should be noted that since the mean reflects all data values in a set, when there are outliers, the value may be affected by the outliers, whereas since the median uses only one value located in the middle, a representative result may be obtained even in the presence of the outliers.

The process of analyzing relationships among data attributes refers to finding combinations of attributes having meaningful correlations with each other in the data, and the relationship analysis may be differently performed according to combinations of attributes between categorical variables (Qualitative) that cannot be numerically expressed but can be arbitrarily quantified and numeric variables (Quantitative) that can be quantified. A categorical-categorical relationship may indicate the number of values corresponding to a pair of each of attribute values using a cross table or a mosaic plot, a numeric-categorical relationship may observe statistical values (mean, median, etc.) for each category or may be visually represented through a box plot, and a numeric-numeric relationship may analyze a correlation between two attributes through a correlation coefficient. It may be confirmed that a correlation coefficient of −1 indicates a negative correlation in which two attributes vary in opposite directions, 0 indicates no correlation, and 1 indicates a positive correlation in which two attributes always vary in the same direction. A relationship between two attributes having the correlation coefficient may also exhibit various patterns, and may be visually represented using a scatter plot.

### 3. Preprocessing and Cleaning Data

Once inspection and exploration are completed, data preprocessing is performed to process the data into a form suitable for a model for machine learning training. The data preprocessing is to clean the data and convert the data into a form understandable by a model, and the data preprocessing may generally include handling missing data, outlier removal, scaling, categorical data encoding, feature selection and extraction, and data transformation. Detailed processes of the data preprocessing may be selectively performed in whole or in part, and a separate machine learning model may also be used for the data preprocessing.

The handling missing data is to process missing data when the missing data exists in data, and the missing data may be represented as NaN (Not a Number) or an empty value or deleted. As the missing data in the data is filled or deleted, completeness of the data may be improved, and when the missing data is filled, a mean value, a median value, a mode, and the like may be used.

The outlier removal is to remove outliers, which are values deviating from a general data pattern, from the data. The outliers may degrade performance of a model and therefore should be removed or replaced, and the outliers may be identified and the corresponding rows or columns may be deleted or replaced with other values.

The data scaling is a process of adjusting the size of data, and through the data scaling, the range of data may be adjusted such that the performance of a model is improved or the convergence speed is enhanced. Through the data scaling, characteristics of data may be aligned to similar ranges, and in general, standardization and normalization may be applied in the data scaling. The standardization is a method of transforming data into a distribution having a mean of 0 and a standard deviation of 1, and mainly transforms by using a mean and a standard deviation, and a standardized value z may be expressed as z=(x−μ)/c (where x denotes an original value, μ denotes the mean, and σ denotes the standard deviation). The normalization is a method of transforming the range of data into [0,1] or [−1,1], and mainly transforms the data by using a minimum value and a maximum value, and a normalized value xₙₒᵣₘ may be expressed as xₙₒᵣₘ=(x−xₘᵢₙ)/(xₘₐₓ−xₘᵢₙ) (where x denotes an original value, xₘᵢₙ denotes the minimum value, and xₘₐₓ denotes the maximum value).

The categorical data encoding is to convert categorical variables expressed as strings or integer values that cannot be directly input to a model into numeric types that can be input to the model. In general, the categorical variables may be converted into numeric values using one-hot encoding or label encoding.

The feature selection and extraction is to select the most useful features for training a model or to extract new features to improve performance of the model, and through such a process, complexity of the model may be reduced and overfitting may be prevented.

The data transformation is to transform data to extract new information or to allow the model to better understand the data, and may include tokenization of text data or preprocessing of image data. Through the data transformation, useful features may be extracted from original data or data may be converted into an appropriate form, thereby improving performance of the model.

Through the data preprocessing as described above, an effect of improving performance and ensuring stability of a machine learning model may be achieved.

Meanwhile, when training the learning model according to one embodiment of the present invention, a process of preprocessing information expressed in natural language and a process of training a language model based on the preprocessed data may be performed.

### 3-1. Text Preprocessing for Large Language Models

When the collected data is in an unpreprocessed state as required, tokenization, cleaning, and normalization may be performed in accordance with an intended use of the corresponding data.

The tokenization refers to dividing given data into a unit called a token, and the unit of the token may generally be defined as a meaningful unit. The tokenization may largely include word tokenization and sentence tokenization.

The tokenization refers to dividing given data into a unit called a token, and the unit of the token may generally be defined as a meaningful unit. The tokenization may largely include word tokenization and sentence tokenization.

The word tokenization refers to a case in which the basis for the token is a word, and here, the word may include not only a word unit but also a phrase or a string having meaning. The word tokenization refers to separating words based on a blank or punctuation, for example, symbols such as a period, a comma, a question mark, a semicolon, and an exclamation mark. However, since removing all punctuation or special characters during the tokenization may cause the token to lose the meaning, a precise algorithm for the tokenization may be required. For example, in cases in which the punctuation is included in a word itself or a special character having meaning is used, simply removing them may not solve the problem. Therefore, during the tokenization, tokenization rules such as Penn Treebank Tokenization rule may be applied.

The sentence tokenization refers to a case of classifying text into a sentence unit, and generally, when data is in an uncleaned state, a corpus may be in a state of not being classified into the sentence unit, so that the sentence tokenization may be required in accordance with an intended use. Such sentence tokenization may be defined by various rules according to a language used and how special characters are used in the corresponding corpus.

A task of classifying the tokens in accordance with the intended use is referred to as tokenization, and before/after the tokenization, the cleaning and the normalization may be performed on text data in accordance with the intended use. The cleaning refers to removing noise data, and the normalization refers to unifying words having different representation methods so as to convert the words into the same words.

The task of the cleaning may be performed prior to the task of the tokenization in order to exclude elements that interfere with the task of the tokenization and to perform the task of the tokenization, but may also be repeatedly performed after the task of the tokenization to remove noise still remaining. The noise data removed in the task of the cleaning are characters having no meaning, and methods of removing unnecessary words may include a method of removing stopwords, a method of removing words having low frequency of occurrence and words having short length, and the like.

The task of the normalization, based on rules, includes unification of words having different notations, unification uppercase and lowercase letters, and the like, and the unification of the uppercase and lowercase letters is a normalization method that may reduce the number of words in English-speaking languages, and since the uppercase letters in English-speaking languages are used only in specific situations such as at the beginning of a sentence and most texts are written in the lowercase letters, the unification of the uppercase and lowercase letters may mostly be performed as a lowercase conversion task of converting the uppercase letters into the lowercase letters.

In order to process natural language in a computing system, a task of preprocessing of digitizing text is required, and for this, a task of mapping each word of the text to a unique integer is performed. Such a mapping process may utilize techniques such as integer encoding, padding, and one-hot encoding.

The integer encoding is one method of assigning integers to words, and in which a vocabulary is generated by arranging words in order of frequency and integers are sequentially assigned from smaller numbers to the words in order of higher frequency. The integer encoding performs the sentence tokenization from text data including multiple sentences, and performs the word tokenization in parallel with the cleaning and normalization tasks. In this case, the words are converted into lowercase letters so that the number of words is unified, and deletion of words may be performed based on stopwords and word lengths. Through this, the word may be recorded as a key, and a frequency of each word may be recorded as a value. After being arranged in order of higher frequency in the text, integers are assigned to words having higher frequencies, thereby performing the integer encoding.

The padding is a task of arbitrarily matching lengths of sentences having different lengths in the text to the same length. A computing system may group sentences having the same length as single matrix to enable parallel computation. That is, in order to perform the parallel computation in the computing system, “0” may be arbitrarily filled in results of the integer encoding of the sentences having different lengths in the text to equalize the lengths of the sentences. That is, after the longest sentence is found from a vocabulary in which integer encoding is completed, and “0” may be added to an integer matrix to correspond to a length of the longest sentence. The computing system may recognize sentences having the same length as one matrix and perform parallel processing, and in this case, the computing system may ignore “0” words recognized as meaningless words. As such, filling a specific value in data to adjust a size (shape) of the data is referred to as padding, and when the number “0” is used for length adjustment, it is referred to as zero padding.

The one-hot encoding is a vector representation method of words, in which a size of a vocabulary corresponds to a dimension of a vector, a value of 1 is assigned to indices of words to be represented, and a value of 0 is assigned to other indices, and a vector represented in this way is referred to as a one-hot vector. The one-hot encoding includes the integer encoding and an index assigning process. After the integer encoding is performed to assign a unique integer to each word, unique integers of the words to be represented is regarded as the indices, and “1” is assigned to the corresponding positions, and “0” is assigned to positions of indices of other words. However, the one-hot encoding has disadvantages in that, as the number of words increases, a space required to store vectors increases (increase of dimensions of vectors) and similarity among words cannot be identified. In order to address such disadvantages, techniques of vectorizing words in a multidimensional space by reflecting latent meanings of words have been proposed, such as Latent Semantic Analysis (LSA) which is a count-based vectorization method, neural network language model (NNLM), recurrent neural network language model (RNNLM), Word2Vec (developed by Google), and FastText (developed by Facebook AI Research) which are prediction-based vectorization methods, and a Global Vectors for Word Representation (GloVe) method which uses both the count-based method and the prediction-based methods.

In order for a computer to understand and process the text, the text needs to be appropriately converted into numbers. Since the performance of natural language processing varies greatly depending on a method of representing words, many techniques to digitize words have been proposed. At present, a word embedding method of vectorizing each word through training of an artificial neural network is most widely used.

Word embedding is a method of representing a word as a vector and converting the word into a dense representation. A result derived through a process of the word embedding is referred to as a dense vector or an embedding vector. Word embedding methodologies include Latent Semantic Analysis (LSA), Word2Vec, FastText, GloVe, and the like.

### 4. Modeling and Training

The artificial neural network (ANN) may be trained using training data. Here, training may refer to a process of determining parameters of the ANN using learning data in order to achieve purposes such as classifying input data, performing regression, or clustering. Representative examples of parameters of the ANN may include a weight assigned to a synapse or a bias applied to a neuron.

The ANN trained by training data may classify or cluster input data according to patterns of the input data. Meanwhile, in the present specification, the ANN trained using the training data may be referred to as a trained model.

Learning methods of the ANN will be described as follows. The learning methods of the ANN may broadly be classified into supervised learning, unsupervised learning, semi-supervised learning, and reinforcement learning.

The supervised learning is a method of machine learning for inferring a function from the training data. And, among the functions inferred in this manner, outputting continuous values may be referred to as regression, and outputting by predicting a class of an input vector may be referred to as classification.

In the supervised learning, the ANN is trained in a state in which labels for the training data are given. Here, the label may refer to ground truth (or a result value) that the ANN needs to infer when the training data are input into the ANN. In the present specification, the ground truth (or the result value) that the ANN needs to infer when the training data are input is referred to as a label or labeling data. In addition, in the present specification, setting the label in the training data for training the ANN is referred to as labeling the training data with labeling data. In this case, the training data and the label corresponding to the training data constitute one training set, and may be input to the ANN in the form of the training set.

Meanwhile, the training data represents a plurality of features, and the labeling of the training data with the label may mean that the label is attached to the features represented by the training data. In this case, the training data may represent features of an input object in the form of a vector. The ANN may infer a function regarding an association between the training data and the labeling data using the training data and the labeling data. And, the parameters of the ANN may be determined (optimized) through an evaluation of the function inferred by the ANN.

The unsupervised learning is a type of machine learning, in which no label is given to the training data. Specifically, unsupervised learning may be a learning method of training the ANN to classify by finding patterns in the training data itself, rather than an association between the training data and the label corresponding to the training data. Examples of unsupervised learning may include clustering or independent component analysis (ICA). In the present specification, the term “grouping” may be used interchangeably with the term “clustering.”

Examples of the ANNs using the unsupervised learning may include a generative adversarial network (GAN) and an autoencoder (AE).

The GAN is a machine learning method in which two different AIs, a generator and a discriminator, compete with each other to improve performance. In this case, the generator is a model that creates new data and may generate new data based on original data. In addition, the discriminator is a model that recognizes patterns of data and may perform a role of discriminating whether input data is the original data or the new data generated by the generator. And, the generator may learn by receiving data that has failed to deceive the discriminator, and the discriminator may learn by receiving data deceived by the generator. Accordingly, the generator may evolve to deceive the discriminator as well as possible, and the discriminator may evolve to better distinguish between the original data and the data generated by the generator.

The AE is a neural network that aims to reproduce an input itself as an output. The AE includes an input layer, at least one hidden layer, and an output layer. In this case, since the number of nodes of the hidden layer is smaller than the number of nodes of the input layer, a dimension of data may decrease, and accordingly, compression or encoding is performed. In addition, data output from the hidden layer is input into the output layer. In this case, since the number of nodes of the output layer is greater than the number of nodes of the hidden layer, a dimension of data may increase, and accordingly, decompression or decoding is performed.

Meanwhile, the AE adjusts connection strengths of neurons through training to represent input data as hidden layer data. In the hidden layer, information is represented with fewer neurons than in the input layer, and the fact that the input data can be reproduced as the output may mean that the hidden layer has discovered and represented hidden patterns from the input data.

The semi-supervised learning is a type of machine learning, and may refer to a learning method in which both the training data with the label and the training data without the label are used. As one technique of the semi-supervised learning, there is a technique of inferring the label of the training data without the label and then performing training using the inferred label, and such a technique may be usefully used in a case in which a cost for labeling is high.

Reinforcement learning is a theory that, when an environment in which an agent can determine what action to take at each moment is given, the agent can find the best path through experience without data. Reinforcement learning may mainly be performed by a Markov Decision Process (MDP). The MDP may be explained as follows: first, what an environment in which information necessary for the agent to take a next action is composed of is given; second, how the agent will act in the environment is defined; what the agent does well is defined to provide a reward and what the agent does poorly is defined to provide a penalty; and fourth, by repeatedly experiencing until a future reward reaches a maximum, an optimal policy is derived.

The ANN may be specified in its structure by a configuration of the model, an activation function, a loss function or a cost function, a learning algorithm, and an optimization algorithm, and the like, and hyperparameters may be preset before training, and thereafter, model parameters may be set through training so that contents thereof may be specified.

For example, factors that determine the structure of the ANN may include the number of hidden layers, the number of hidden nodes included in each hidden layer, an input feature vector, and a target feature vector.

The hyperparameters include various parameters that need to be initially set for training, such as initial values of the model parameters. And, the model parameters include various parameters to be determined through training. For example, the hyperparameters may include initial values of weights between nodes, initial values of biases between nodes, a mini-batch size, the number of training iterations, a learning rate, and the like. And, model parameters may include weights between nodes, biases between nodes, and the like.

The loss function may be used as an indicator (criterion) for determining optimal model parameters in a training process of the ANN. In the ANN, training refers to a process of manipulating the model parameters to reduce the loss function, and a purpose of training may be regarded as determining the model parameters that minimize the loss function. The loss function may mainly use Mean Squared Error (MSE) or Cross Entropy Error (CEE), but the present invention is not limited thereto. The CEE may be used in a case in which ground truth labels are one-hot encoded. One-hot encoding is an encoding method in which only the neuron corresponding to ground truth is set to a ground truth label value of 1, and a neuron not corresponding to the ground truth is set to a ground truth label value of 0.

In machine learning or deep learning, learning optimization algorithms may be used to minimize the loss function, and the learning optimization algorithms include Gradient Descent (GD), Stochastic Gradient Descent (SGD), Momentum, Nesterov Accelerated Gradient (NAG), Adaptive Gradient (Adagrad), AdaDelta, Root Mean Square Propagation (RMSProp), Adam, Nadam, and the like.

GD is a technique of adjusting the model parameters in a direction to reduce a value of the loss function in consideration of a gradient of the loss function in a current state. A direction of adjusting the model parameters is referred to as a step direction, and a magnitude of adjustment is referred to as a step size. In this case, the step size may refer to a learning rate. The GD obtains a gradient by partially differentiating the loss function with respect to each model parameter, and may update the model parameters by changing the model parameters in a direction of the obtained gradient by the learning rate.

SGD is a technique of dividing learning data into mini-batches and performing the GD for each mini-batch to increase a frequency of performing the gradient descent.

Adagrad, AdaDelta, and RMSProp are techniques of increasing optimization accuracy by adjusting the step size in SGD. Momentum and NAG in SGD are techniques of increasing optimization accuracy by adjusting the step direction. Adam is a technique of increasing optimization accuracy by adjusting the step size and the step direction through combining Momentum and RMSProp. Nadam is a technique of increasing optimization accuracy by adjusting the step size and the step direction through combining NAG and RMSProp.

A learning speed and accuracy of the ANN is largely influenced not only by a structure of the ANN and a type of learning optimization algorithm, but also by the hyperparameters. Therefore, in order to obtain a good learning model, it is important not only to determine an appropriate structure of the ANN and a learning algorithm but also to set appropriate hyperparameters.

Generally, the hyperparameters are experimentally set to various values to try to train the ANN, and they are set to an optimal value that provides a stable learning speed and accuracy according to a learning result.

Embodiments according to a material property prediction system and prediction method of the present invention may be applied to a field of new material development based on graphs and text descriptions related to properties of a material. For example, the embodiments of the present invention may be applied to predicting battery characteristics such as shear modulus, bulk modulus, and bandgap of a battery material. In particular, the present embodiment may be applied to development of a manganese (Mn)-rich cathode material that has a structure different from an existing cathode material applied to a battery and can utilize 60% or more of Mn, which is a relatively inexpensive material. In addition, the embodiments of the present invention may be applicable to prediction fields of a crystal structure, a molecular structure, a protein structure, a catalyst structure, and structures of other frameworks such as a metal-organic framework (MOF), and properties.

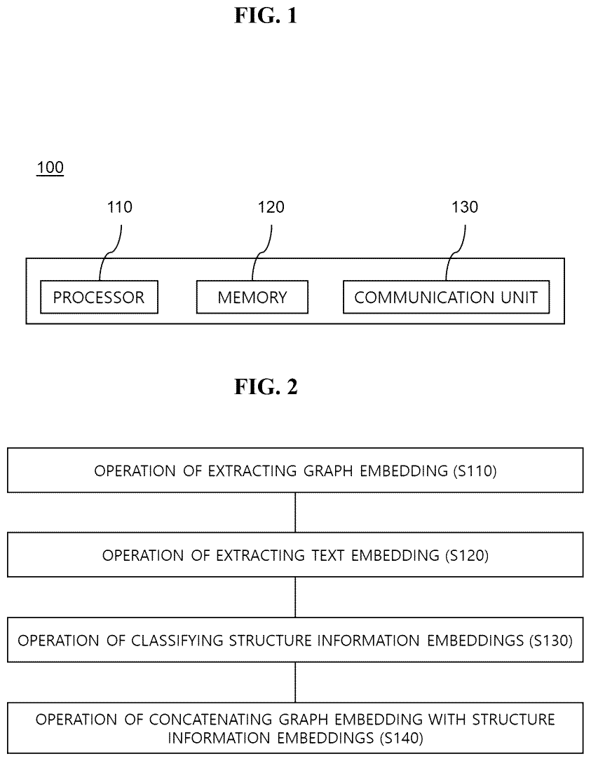

FIG. 1 is a schematic diagram of an electronic device according to one embodiment of the present invention.

As shown in FIG. 1, an electronic device 100 according to one embodiment of the present invention may include at least one processor 110, a memory 120, and a communication unit 130. The electronic device 100 is a basic configuration for performing a computing environment, and in another embodiment, the electronic device 100 may be implemented to additionally or alternatively include some other components, may be implemented as a single entity or a plurality of entities, or may be implemented with only some of the disclosed components. Components inside or outside the electronic device 100 or at least some of the components may transmit or receive data or signals by being connected to each other through a bus, a general purpose input/output (GPIO), a serial peripheral interface (SPI), or a mobile industry processor interface (MIPI).

The processor 110 may mean a set of one or more processors unless explicitly expressed otherwise in context, and may drive software (e.g., instructions, programs, etc.) stored in at least the memory 120 to control the processor 110 and the components of the electronic device 100. In addition, the processor 110 may perform various operations such as computation, processing, data generation, or processing, and may read data or the like from the memory 120 or store the data or the like into the memory 120. The processor 110 may include at least one core and a processor for data analysis, machine learning (ML), or deep learning (DL), such as a central processing unit (CPU), a general purpose graphics processing unit (GPGPU), and a tensor processing unit (TPU). The processor 110 may read software stored in the memory 120 to perform data processing for ML (or DL) of the present invention. According to one embodiment of the present disclosure, the processor 110 may perform computations for training a neural network. The processor 110 may perform calculations for training a neural network such as processing input data for training in DL, extracting features from the input data, calculating errors, updating weights of the neural network using backpropagation. At least one of the CPU, GPGPU, and TPU of the processor 110 may process training of a neural network model. For example, the CPU and the GPGPU may together process training of the neural network model and data classification using the neural network model. In addition, in one embodiment of the present disclosure, at least one processor 110 of the electronic device 100 may be used together to process training of the neural network model and data classification using the neural network model.

The memory 120 is for storing various data, and the data may be data obtained, processed, or used by at least one component of the electronic device 100 and may include software (e.g., an instruction, a program, etc.). The memory 120 may mean a set of one or more memories unless explicitly expressed otherwise in context, and may include a storage medium of at least one type among a flash memory type, a hard disk type, a multimedia card micro type, a card-type memory (e.g., an SD or XD memory), a RAM, a static random access memory (SRAM), a read-only memory (ROM), an electrically erasable programmable read-only memory (EEPROM), a programmable read-only memory (PROM), a magnetic memory, a magnetic disk, an optical disk, and a web storage that performs a storage function on the Internet. The instruction, the program, or the software stored in the memory 120 may be used to refer to an operating system for controlling the components of the electronic device 100, an application, or middleware that provides various functions to the application so that the application can utilize the components of the electronic device 100. In one embodiment, when the processor 110 performs a specific computation, the memory 120 may store the instructions that are performed by the processor 110 and correspond to the specific computation.

The communication unit 130 may perform wireless or wired communication between the electronic device 100 and another device (e.g., a user terminal or another server), and the communication unit 130 may use wireless communication systems according to methods such as Enhanced Mobile Broadband (eMBB), Ultra-Reliable Low-Latency Communication (URLLC), Massive Machine Type Communications (mMTC), long-term evolution (LTE), long-term evolution—advanced (LTE-A), New Radio (NR), Universal Mobile Telecommunications System (UMTS), Global System for Mobile Communication (GSM), Code Division Multiple Access (CDMA), Wideband Code Division Multiple Access (WCDMA), Time Division Multiple Access (TDMA), Frequency Division Multiple Access (FDMA), Orthogonal Frequency Division Multiple Access (OFDMA), Single Carrier Frequency Division Multiple Access (SC-FDMA), Wireless Broadband (South Korea) (WiBro), Wireless Local Area Network (WLAN or WiFi), Bluetooth, Near Field Communication (NFC), Global Positioning System (GPS), or Global Navigation Satellite System (GNSS). In addition, the communication unit 130 can use various wired communication systems such as a Universal Serial Bus (USB), an High Definition Multimedia Interface (HDMI), a recommended standard-232 (RS-232), a plain old telephone service (POTS), a public switched telephone network (PSTN), an x digital subscriber line (xDSL), a rate adaptive DSL (RADSL), a multi rate DSL (MDSL), a very high speed DSL (VDSL), a universal asymmetric DSL (UADSL), a high bit rate DSL (HDSL), and a local area network (LAN). In one embodiment of the present invention, the communication unit 130 may be configured regardless of a communication mode such as wired or wireless, and may be configured with various networks such as a personal area network (PAN) or a wide area network (WAN). In addition, the network may be a known world wide web (WWW), and may also use a wireless transmission technology used for short-range communication such as an infrared data association (IrDA) or Bluetooth.

The electronic device 100 according to the embodiment of the present invention may execute software that configures the material property prediction system or the material property prediction method.

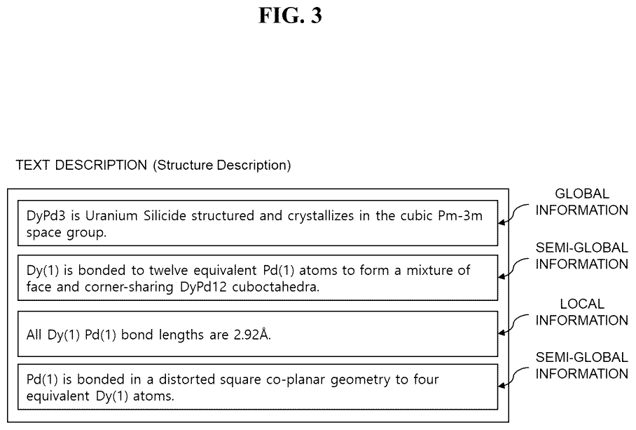

As shown in FIG. 2, the material property prediction method according to one embodiment of the present invention may include extracting a graph embedding by inputting material information into a first AI model (S110), extracting a text embedding by inputting a text description of a crystal structure of a material into a second AI model (S120), classifying the text embedding into a plurality of structure information embeddings (S130), and concatenating the graph embedding with at least one of the plurality of structure information embeddings (S140).

In operation S110 of extracting a graph embedding by inputting the material information into the first AI model, the graph embedding including connectivity and interaction patterns in the crystal structure may be generated based on the material information about the crystal structure of the material. The first AI model of one embodiment of the present invention may generate the graph embedding, which is a graph representation of the crystal structure of the material, by repeatedly refining a graph node corresponding to an atom of the crystal structure and connection information between the atoms. A graph-based structural embedding (the graph embedding) of one embodiment may be generated by a graph-based model that derives an embedding through a graph input for the crystal structure of the material. For example, one embodiment may use a connectivity optimized graph networks (coGN) model, which shows excellent performance in capturing connectivity of the crystal structure, among various graph-based models. In one embodiment, the coGN model may receive graph data as input, encode the graph data to generate a vector, and specifically, encode a local atomic environment in the crystal structure of the material to predict an attribute (characteristic, property) that depend on short-range interactions. Such a graph-based model may be excellent at capturing local information around the atoms, that is, the atoms and short-range interactions around the atoms. However, such a graph model also has a disadvantage of being unable to explain nonlocal information that plays an important role in determining properties of a material in which long-range interactions between the atoms or global structural characteristics are important. To address this, one embodiment of the present invention may improve material property prediction performance by training a model through concatenating the graph (structural) embedding of the graph model with the text embedding based on a language model.

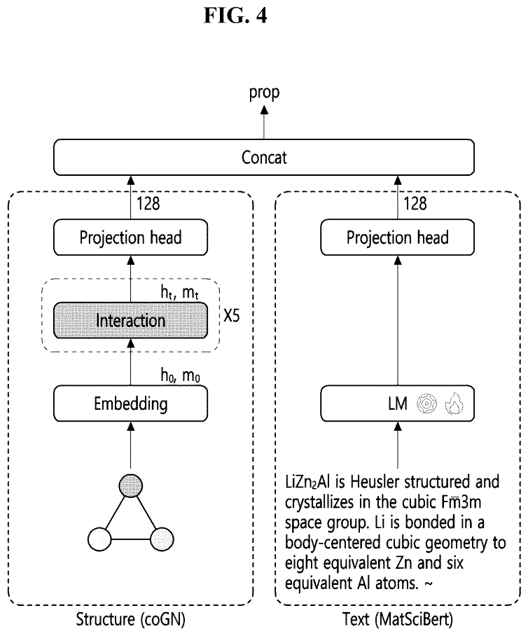

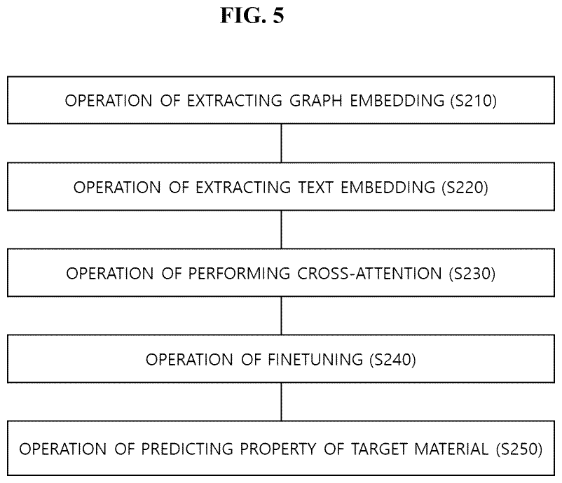

Referring to FIG. 4, the first AI model may include an embedding layer encoding the graph node for the atom of the crystal structure of the material information and the connection information between the atoms, an interaction layer repeatedly refining a representation of the material based on the graph node and the connection information, and a first projection head projecting the structural embedding refined in the interaction layer into a 128-dimensional vector. The embedding layer may encode initial features of the atoms and the connection information between the atoms as a starting point of the subsequent interaction layer and transfer them to the interaction layer. The interaction layer may repeatedly refine a graph representation of the material through message passing between the graph nodes through a plurality of iterations, for example, five iterations (here, in FIG. 4, h denotes a node and m denotes an edge embedding). The refined structural embedding may be projected into the 128-dimensional vector by the first projection head.

In operation S120 of extracting the text embedding by inputting the text description of the crystal structure of the material into the second AI model, the text description collected in relation to the crystal structure of the material may be input into the second AI model (language model (LM)). In one embodiment of the present invention, the text description related to the material may be generated from a text generator (e.g., the Robocrystallographer package) that generates the text description of the crystal structure of the material in a manner similar to that in which an actual crystallographer analyzes the structure.

In one embodiment, the text description of the crystal structure generated by the text generator may include symmetry of the crystal structure, a local environment, and extended connectivity. In addition, the text description may include information for identifying molecule names, component orientation, heterostructure information, and the like. For example, in one embodiment, when the material information “SnO₂” is given as input to the text generator, a text description may be output such as:

“SnO₂ is Rutile structured and crystallizes in the tetragonal P4_2/mnm space group. The structure is three-dimensional. Sn(1) is bonded to six equivalent O(1) atoms to form a mixture of edge and corner-sharing SnO₆ octahedra. The corner-sharing octahedral tilt angles are 51°. All Sn(1)-O(1) bond lengths are 2.09 Å. O(1) is bonded in a trigonal planar geometry to three equivalent Sn(1) atoms.” Such a text description may include extensive information, including global characteristics (e.g., a space group and a crystal type), local information (e.g., a bond length and a coordination environment), and semi-global characteristics (e.g., geometry, connectivity, and a structural arrangement). The text description generated and collected from the text generator may be input into the second AI model based on the LM to extract the text embedding. In this manner, the text description of the material obtained may be embedded based on the LM trained on materials science literature. In one embodiment of the present invention, as the second AI model, MatSciBERT, which is the LM trained on materials science literature, may be used, and the second AI model may receive the text description as input to generate the text embedding.

As shown in FIG. 3, the text description generated for the material includes global information, semi-global information, and local information on the crystal structure of the corresponding material. That is, in the text description configured in the sentence form for the crystal structure of the material, each sentence may be classified as describing the global information, the semi-global information, or the local information of the crystal structure of the material based on words, verbs, adjectives, and the like included in one sentence. For example, in a text description for a material “DyPd3” in FIG. 3, a sentence “DyPd3 is Uranium Silicide Structured and crystallizes in the cubic Pm-3m space group.” includes words such as “Uranium Silicide,” “cubic,” and “space group,” and words such as “structured” and “crystallizes,” in the sentence, so the sentence may be classified as representing the global information including a space group, a crystal type, and dimensionality of the crystal structure of the material. In addition, a sentence “Dy(1) is bonded to twelve equivalent Pd(1) atoms to form a mixture of face and corner-sharing DyPd12 cuboctahedra.” includes words such as “twelve equivalent Pd(1) atoms,” “face and corner-sharing,” and “cuboctahedra,” in the sentence, so the sentence may be classified as representing the semi-global information including connectivity, a structural arrangement, and geometry of the crystal structure of the material. Similarly, a sentence “Pd(1) is bonded in a distorted square co-planar geometry to four equivalent Dy(1) atoms.” includes words such as “distorted square co-planar geometry” and “four equivalent Dy(1) atoms,” in the sentence, so the sentence may also be classified as representing the semi-global information. In addition, a sentence “All Dy(1)-Pd(1) bond lengths are 2.92 Å.” includes words such as “bond lengths” and “2.92 Å,” in the sentence, so the sentence may also be classified as representing the local information including a bond length between the atoms or a coordination environment of the crystal structure of the material.

That is, in operation S120 of extracting the text embedding by inputting the text description of a crystal structure of the material into the second AI model, when the second AI model encodes each sentence of the text description, the second AI model may generate a plurality of structure information embeddings based on words included in the sentence.

Referring to FIG. 4, the second AI model may include a language model (LM) for receiving the text description of the crystal structure of the material and generating the text embedding, and a second projection head projecting the text embedding into a 128-dimensional vector. The LM may generate and classify three types of structure information embeddings (a global information embedding, a semi-global information embedding, and a local information embedding) for each sentence based on words included in each sentence included in the input text description of the crystal structure of the material. The generated text embedding may be projected into a 128-dimensional vector by the second projection head.

In operation S130 of classifying the text embedding into a plurality of structure information embeddings, the structure information embeddings generated from a plurality of sentences included in a single text description through the second AI model may include the global information embedding, the semi-global information embedding, and the local information embedding, and the global information embedding, the semi-global information embedding, and the local information embedding can be distinguished from each other. In one embodiment, the second AI model may further include an identifier in each embedding to identify each structure information embedding.

In operation S140 of concatenating the graph embedding and at least one of the plurality of structure information embeddings, the graph embedding (structural embedding) generated through the first AI model and the structure information embedding (text embedding) generated through the second AI model may be concatenated in a concatenate layer.

The graph representation (structural embedding) refined through the interaction layer in the first AI model may pass through the first projection head that projects learned features into the 128-dimensional vector, and may be concatenated with the text embedding in the concatenate layer. In addition, in one embodiment, the structural embedding may be concatenated with at least one of the three structure information embeddings of the text embedding. The text embedding including the structure information embeddings may pass through the second projection head and may be concatenated with the structural embedding (graph embedding) in the concatenate layer. That is, in one embodiment of the present invention, the graph embedding may be concatenated with the global information embedding, in another embodiment, the graph embedding may be concatenated with the semi-global information embedding, in still another embodiment, the graph embedding may be concatenated with the local information embedding, in still another embodiment, the graph embedding may be concatenated with the global information embedding and the semi-global information embedding, and in still another embodiment, the graph embedding may be concatenated with the text embedding including all structure information embeddings.

One embodiment of the present invention may include operation S150 of predicting a property of a target material, and in this case, a multimodal embedding (a concatenation of the graph embedding and the text embedding) concatenated in the concatenate layer may be input into a fully connected layer to predict the property of the target material.

The material property prediction method and the material property prediction system for executing the method according to the embodiments of the present invention may exhibit improved prediction performance compared to models predicting the properties of the material. The embodiments of the present invention were evaluated in performance, as shown in Table 1 below, in comparison with existing models for predicting the crystal structure of the material, that is, a graph model (structure only) using only structural information of the crystal structure of the material and a language model (text only) using only the text description of the crystal structure of the material.

TABLE 1

| MAE(R2) | Shear Modulus | Bulk modulus |
|---|---|---|
| Structure only | 0.0883 ± 0.0061 (0.884) | 0.0554 ± 0.0088 (0.932) |
| Text only | 0.0825 ± 0.0032 (0.895) | 0.0455 ± 0.0005 (0.949) |
| (\textcircled{1} + \textcircled{2} + | | |
| \textcircled{3}) | | |
| Structure + | 0.0886 ± 0.0009 (0.875) | 0.0546 ± 0.0002 (0.919) |
| Text(\textcircled{1}) | | |
| Structure + | 0.0749 ± 0.0035 (0.908) | 0.0399 ± 0.0018 (0.960) |
| Text(\textcircled{2}) | | |
| Structure + | 0.0872 ± 0.0021 (0.882) | 0.0516 ± 0.0008 (0.917) |
| Text(\textcircled{3}) | | |
| Structure + | 0.0759 ± 0.0013 (0.906) | 0.0385 ± 0.0005 (0.962) |
| Text(\textcircled{1} + \textcircled{2}) | | |
| Structure + | 0.0756 ± 0.0008 (0.907) | 0.0406 ± 0.0028 (0.960) |
| Text(\textcircled{1} + \textcircled{2} + | | |
| \textcircled{3}) | | |

Learning models of embodiments evaluated in comparison with the existing graph model and the existing language model may include a first model (Structure+Text (\textcircled{1})) trained with a multimodal embedding in which the graph embedding and the global information embedding are concatenated, a second model (Structure+Text (\textcircled{2})) trained with a multimodal embedding in which the graph embedding and the semi-global information embedding are concatenated, a third model (Structure+Text (\textcircled{3})) trained with a multimodal embedding in which the graph embedding and the local information embedding are concatenated, a fourth model (Structure+Text (\textcircled{1}+\textcircled{2})) trained with a multimodal embedding in which the graph embedding, the global information embedding, and the semi-global information embedding are concatenated, and a fifth model (Structure+Text (\textcircled{1}+\textcircled{2}+\textcircled{3})) trained with a multimodal embedding in which the graph embedding and all of the structure information embeddings are concatenated.

Performance of the models was measured using a mean absolute error (MAE) for main characteristics of the material, that is, a shear modulus and a bulk modulus of the material, and a lower MAE value means a higher prediction accuracy (prediction performance) (R2 denotes a coefficient of determination, and a higher R2 means higher prediction performance).

As shown in Table 1, the graph model (structure only), which is a baseline model, using only structural information of the material, shows 0.0883 for the shear modulus and 0.0554 for the bulk modulus, and the language model (text only), which predicts based on the text description of the crystal structure of the material, shows 0.0825 for the shear modulus and 0.0455 for the bulk modulus, and, therefore, the language model (text only) based on the text description shows an improved performance compared to the graph model.

The first model (Structure+Text (\textcircled{1})) among embodiments of the present invention shows 0.0886 for the shear modulus and 0.0546 for the bulk modulus, and, therefore, compared to the graph model and the language model, which are the baseline models, shows lower prediction performance for the shear modulus but shows improved prediction performance for the bulk modulus compared to the graph model. The second model (Structure+Text (\textcircled{2})) shows 0.0749 for the shear modulus and 0.0399 for the bulk modulus, and, therefore, compared to the graph model and the language model, which are the baseline models, shows improved prediction performance. In particular, the second model shows significantly improved prediction performance for the shear modulus compared to the baseline models. The third model (Structure+Text (\textcircled{3})) shows 0.0872 for the shear modulus and 0.0516 for the bulk modulus, and, therefore, shows improved performance compared to the graph model, which is the baseline model, but shows lower prediction performance compared to the language model using all text descriptions. The fourth model (Structure+Text (\textcircled{1}+\textcircled{2})) shows 0.0759 for the shear modulus and 0.0385 for the bulk modulus, and, therefore, compared to the graph model and the language model, which are the baseline models, shows improved prediction performance. In particular, the fourth model shows significantly improved prediction performance for the bulk modulus compared to the baseline models. The fifth model (Structure+Text (\textcircled{1}+\textcircled{2}+\textcircled{3})) shows 0.0756 for the shear modulus and 0.0406 for the bulk modulus, and, therefore, shows improved prediction performance compared to the baseline models.

As described above, in the evaluation of prediction performance of the baseline models and the embodiments of the present invention, the second model trained by concatenating the graph embedding (the structural embedding) of a graph model with the semi-global information embedding among the text embeddings generated from the language model based on the text description shows a result of the highest performance improvement in prediction of the shear modulus. Through this, in prediction of mechanical properties of the material such as the shear modulus, importance of the semi-global information such as geometry and connectivity of the crystal structure can be confirmed. In addition, the fourth model trained by concatenating the graph embedding with the global information embedding and the semi-global information embedding shows a result of the highest performance improvement in prediction of the bulk modulus. Through this, in prediction of properties of the material such as the bulk modulus, importance of the global characteristics such as a crystal type and a space group of the crystal structure and the semi-global characteristics such as geometry and connectivity of the crystal structure can be confirmed.

Through this, it has been confirmed that the text description of the crystal structure can complement a graph model, fill a gap related to the global and semi-global characteristics that are difficult to be identified in the graph model, and improve overall performance of the model.

As shown in FIG. 5, a material property prediction method according to another embodiment of the present invention may include extracting a graph embedding by inputting material information into a first AI model executed by a processor S210, extracting a text embedding by inputting a text description of a crystal structure of a material into a second AI model executed by the processor S220, performing cross-attention on the graph embedding and the text embedding through the processor S230, fine tuning the second AI model in which pre-training is completed, S240, and predicting a property of a target material by inputting target material information into the first AI model S250.

In operation S210 of extracting the graph embedding by inputting the material information into the first AI model, the graph embedding including connectivity and interaction patterns in the crystal structure may be generated based on the material information about the crystal structure of the material. The first AI model of another embodiment of the present invention may generate the graph embedding, which is a graph representation of the crystal structure of the material, by repeatedly refining a graph node corresponding to an atom of the crystal structure and connection information between the atoms. A graph-based structural embedding (graph embedding) of another embodiment may be generated by a graph-based model that derives an embedding through a graph input for the crystal structure of the material. For example, another embodiment may use a connectivity optimized graph networks (coGN) model, which shows excellent performance in capturing the connectivity of the crystal structure, among various graph-based models. In another embodiment, the coGN model may receive graph data as input, encode the graph data to generate a vector, and specifically, encode a local atomic environment in the crystal structure of the material to predict an attribute (characteristic, property) that depend on short-range interactions. Such a graph-based model may be excellent at capturing local information around the atoms, that is, the atoms and short-range interactions around the atoms. However, such a graph model also has a disadvantage of being unable to explain nonlocal information that plays an important role in determining properties of a material in which long-range interactions between the atoms or global structural characteristics are important. To address this, another embodiment of the present invention may improve material property prediction performance by training a model through performing cross-attention on the graph (structural) embedding of the graph model and the text embedding based on a language model.

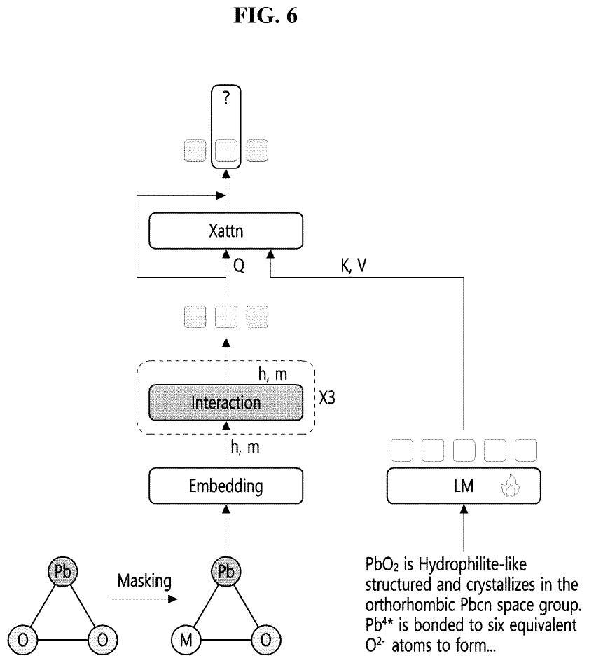

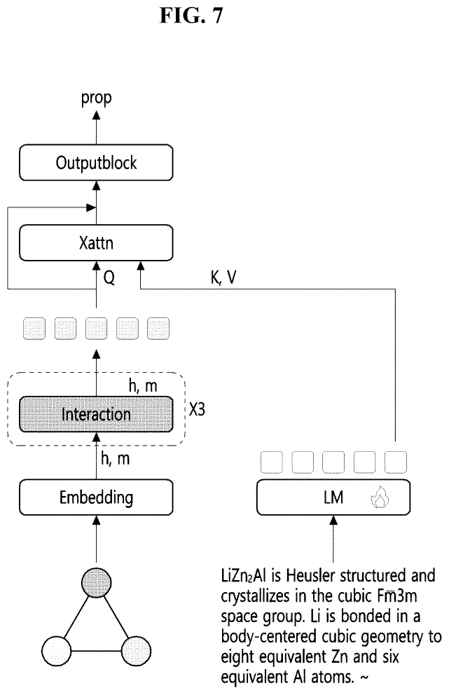

Referring to FIG. 6, the first AI model may include an embedding layer encoding the graph node for the atom of the crystal structure of the material information and the connection information between the atoms, and an interaction layer repeatedly refining a representation of the material based on the graph node and the connection information. The embedding layer may encode initial features of the atoms and the connection information between the atoms as a starting point of the subsequent interaction layer and transfer them to the interaction layer. The interaction layer may repeatedly refine a graph representation of the material through message passing between graph nodes through a plurality of iterations, for example, three iterations (in FIGS. 6 and 7, h denotes a node and m denotes an edge embedding). The refined structural embedding may be transferred to a cross-attention layer (Xattn), in which the cross-attention may be performed with the text embedding. Here, the first AI model is a decoder of a transformer, and the graph embedding generated from the first AI model is set as a query in the cross-attention layer. In pre-training of the model, the query may predict a masked token by referring to the text embedding of the second AI model, which is an encoder. That is, in the pre-training of the model, the masked token is generated by masking the graph node in material information, and which element the masked token originally is predicted in the cross-attention layer.

In operation S220 of extracting the text embedding by inputting the text description of the crystal structure of the material into the second AI model, the text description collected in relation to the crystal structure of the material may be input into the second AI model (language model (LM)). In another embodiment of the present invention, the text description related to the material may be generated from a text generator (e.g., the Robocrystallographer package) that generates the text description of the crystal structure of the material in a manner similar to that in which an actual crystallographer analyzes the structure.

In another embodiment, the text description generated by the text generator regarding the crystal structure may include symmetry, a local environment, and extended connectivity of the crystal structure. In addition, the text description may include information for identifying molecule names, component orientation, heterostructure information, and the like. For example, in one embodiment, when the material information “SnO₂” is given as input to the text generator, a text description may be output such as: “SnO₂ is Rutile structured and crystallizes in the tetragonal P4_2/mnm space group. The structure is three-dimensional. Sn(1) is bonded to six equivalent O(1) atoms to form a mixture of edge and corner-sharing SnO₆ octahedra. The corner-sharing octahedral tilt angles are 51°. All Sn(1)-O(1) bond lengths are 2.09 Å. O(1) is bonded in a trigonal planar geometry to three equivalent Sn (1) atoms.” Such a text description may include extensive information, including global characteristics (e.g., a space group and a crystal type), local information (e.g., a bond length and a coordination environment), and semi-global characteristics (e.g., geometry, connectivity, and a structural arrangement). The text description generated and collected from the text generator may be input into the second AI model based on the LM to extract the text embedding. In this manner, the text description of the material obtained may be embedded based on the LM trained on materials science literature. In one embodiment of the present invention, as the second AI model, MatSciBERT, which is the LM trained on materials science literature, may be used, and the second AI model may receive the text description as input to generate the text embedding.

Referring to FIG. 3, the text description generated for the material includes global information, semi-global information, and local information on the crystal structure of the corresponding material. That is, in the text description configured in the sentence form for the crystal structure of the material, each sentence may be classified as describing the global information, the semi-global information, or the local information of the crystal structure of the material based on words, verbs, adjectives, and the like included in one sentence. For example, in a text description for a material “DyPd3” in FIG. 3, a sentence “DyPd3 is Uranium Silicide Structured and crystallizes in the cubic Pm-3m space group.” includes words such as “Uranium Silicide,” “cubic,” and “space group,” and words such as “structured” and “crystallizes,” in the sentence, so the sentence may be classified as representing the global information including a space group, a crystal type, and dimensionality of the crystal structure of the material. In addition, a sentence “Dy(1) is bonded to twelve equivalent Pd(1) atoms to form a mixture of face and corner-sharing DyPd12 cuboctahedra.” includes words such as “twelve equivalent Pd(1) atoms,” “face and corner-sharing,” and “cuboctahedra,” in the sentence, so the sentence may be classified as representing the semi-global information including connectivity, a structural arrangement, and geometry of the crystal structure of the material. Similarly, a sentence “Pd(1) is bonded in a distorted square co-planar geometry to four equivalent Dy(1) atoms.” includes words such as “distorted square co-planar geometry” and “four equivalent Dy(1) atoms,” in the sentence, so the sentence may also be classified as representing the semi-global information. In addition, a sentence “All Dy(1)-Pd(1) bond lengths are 2.92 Å.” includes words such as “bond lengths” and “2.92 Å,” in the sentence, so the sentence may also be classified as representing the local information including a bond length between the atoms or a coordination environment of the crystal structure of the material.

That is, in operation S220 of extracting the text embedding by inputting the text description of a crystal structure of the material into the second AI model, when the second AI model encodes each sentence of the text description, the second AI model may generate a plurality of structure information embeddings based on words included in the sentence.

Referring to FIG. 6, the second AI model may include a language model (LM) for receiving the text description of the crystal structure of the material and generating the text embedding, and a second projection head projecting the text embedding into a 128-dimensional vector. The LM may generate and classify three types of structure information embeddings (a global information embedding, a semi-global information embedding, and a local information embedding) for each sentence based on words included in each sentence included in the input text description of the crystal structure of the material. Referring to FIG. 6, the second AI model, which is the LM, may be an encoder of the transformer, and the text embedding generated by the second AI model may function as a key and a value referred to by the graph embedding, which is a query. That is, in the cross-attention layer, the graph embedding, which is the query, may refer to the text embedding to predict the masked token.

In operation S230 of performing the cross-attention on the graph embedding and the text embedding, the cross-attention may be performed on the graph embedding of the first AI model, which is the decoder of the transformer, and the text embedding of the second AI model, which is the encoder, in the cross-attention layer (Xattn). That is, the graph embedding of the first AI model may be set as the query, and the text embedding of the second AI model may be set as the key and the value that the query refers to. In pre-training of the model, the masked token generated by masking any one of the graph nodes may be predicted, by referring to the text embedding, as to which element the masked token originally is. As such, a learning model of another embodiment of the present invention may be pre-trained by generating the masked token from graph information of the crystal structure of the material and repeating a process of predicting the masked token.

In operation S240 of fine tuning a second AI model in which pre-training is completed, the second AI model having a large size may be fine tuned by a low-rank adaptation (LoRA) method. The LoRA method was developed to improve shortcomings of conventional full fine tuning, and when fine tuning is performed using the LoRA method, there is an advantage in that pre-trained weights are kept fixed, and instead, rank decomposition matrices for changes of layers are optimized during adaptation, so that some layers of the neural network may be indirectly trained. In another embodiment, the second AI model may freeze weights of a pre-trained model and insert rank decomposition matrices into each layer, thereby greatly reducing the number of trainable parameters. Through this, computation and memory requirements can be reduced while performance can be maintained similarly to that of the full fine tuning.

In operation S250 of predicting the property of the target material by inputting the target material information into the first AI model, referring to FIG. 7, an output block may be added to a rear end of a learning model in which fine tuning is completed to predict the property of the target material.

As another embodiment, the material property prediction model of the present invention as described above may include a prediction model fine tuned by the LoRA method using the pre-trained prediction model implemented from operation S210 to operation S230, and a prediction model trained from scratch from operation S210 to operation S250 without pre-training.

In addition, in another embodiment of the present invention, a prediction model may concatenate the graph embedding generated from the first AI model and the text embedding generated from the second AI model in the concatenate layer. The graph representation (structural embedding) refined through the interaction layer in the first AI model may pass through the first projection head that projects learned features into the 128-dimensional vector, and may be concatenated with the text embedding in the concatenate layer. In addition, in another embodiment, the structural embedding may be concatenated with at least one of three structure information embeddings of the text embedding. The text embedding including the structure information embeddings may pass through the second projection head and may be concatenated with the structural embedding (graph embedding) in the concatenate layer. That is, in another embodiment of the present invention, the graph embedding may be concatenated with the global information embedding, in another embodiment the graph embedding may be concatenated with the semi-global information embedding, in another embodiment the graph embedding may be concatenated with the local information embedding, in still another embodiment the graph embedding may be concatenated with the global information embedding and the semi-global information embedding, and in yet another embodiment the graph embedding may be concatenated with the text embedding including all of the structure information embeddings.

The material property prediction method according to the embodiments of the present invention and a material property prediction system executing the method may exhibit improved prediction performance compared to existing models for predicting properties of materials. The embodiments of the present invention were evaluated in performance, as shown in Table 2 below, in comparison with existing models for predicting the crystal structure of the material, that is, a graph model (coGN) using only structural information of the crystal structure of the material and a language model (MatSciBERT) using only the text description of the crystal structure of the material.

TABLE 2

| | | | Concat- | First | Second |
|---|---|---|---|---|---|
| | Graph | Language | enated | Learning | Learning |
| | Model | Model | Model | Model | Model |
| | (coGN) | (MatSciBert) | (Concat) | (Xattn) | (Xattn(ft)) |
| Total | 0.673 | 0.390 | 0.353 | 0.277 | 0.256 |
| Energy | | | | | |
| Bandgap | 0.381 | 0.420 | 0.432 | 0.394 | 0.354 |
| Shear | 0.0911 | 0.0894 | 0.0751 | 0.0718 | 0.0694 |
| Modulus | | | | | |
| Bulk | 0.0498 | 0.0527 | 0.0406 | 0.0415 | 0.0392 |
| Modulus | | | | | |

Models serving as baselines for performance evaluation are the graph model and the language model, the graph model used a connectivity optimized graph networks (coGN) model showing excellent performance in capturing connectivity of the crystal structure, and the language model used Materials Science—Bidirectional Encoder Representations from Transformers (MatSciBERT), which is a language model trained on materials science literature.

The embodiments of the present invention, which are compared in material property prediction performance with the baseline models, may include a concatenated model in which the graph embedding and the text embedding are concatenated, a first learning model (Xattn) in which the graph embedding and the text embedding are cross-attended without pre-training; and a second learning model (Xattn (ft)) in which the first learning model is fine tuned after pre-training is completed.

Performance of the models was measured using a mean absolute error (MAE) for main characteristics of the material, that is, a bandgap, a shear modulus and a bulk modulus of the material, and a lower MAE value means a higher prediction accuracy (prediction performance).

As shown in [Table 2], the graph model (coGN), which is a baseline model, using only structural information of the material, shows 0.381 for the bandgap, 0.0911 for the shear modulus, and 0.0498 for the bulk modulus, and the language model (MatSciBERT), which predicts based on the text description of the crystal structure of the material, shows 0.420 for the bandgap, 0.0894 for the shear modulus, and 0.0527 for the bulk modulus.

The concatenated model (Concat) among the embodiments of the present invention shows improved performance in the shear modulus and the bulk modulus compared to the graph model and the language model. The first learning model (Xattn), which is trained without pre-training, shows 0.394 for the bandgap, 0.0718 for the shear modulus, and 0.0415 for the bulk modulus, and shows improved prediction performance for the shear modulus and the bulk modulus compared to the graph model, which is the baseline model, and shows improved performance for all of the bandgap, the shear modulus, and the bulk modulus compared to the language model, which is the baseline model. The first learning model (Xattn) shows a result of improved prediction performance for the bandgap and the shear modulus compared to the concatenated model. The second learning model (Xattn (ft)) shows significantly improved prediction performance for all of the bandgap, the shear modulus, and the bulk modulus compared to the graph model, the language model, which are the baseline models, the concatenated model, and the first learning model.

As described above, in the evaluation of prediction performance of the baseline models and the other embodiments of the present invention, the second learning model, which is fine tuned from a pre-trained model by performing the cross-attention on the graph embedding and the text embedding, shows a result of the highest performance improvement in evaluation of material property prediction performance.

In one embodiment of the present invention, the present invention may be implemented as an application specific integrated circuit (ASIC) that is manufactured to meet special functions for a specific application field and device.

The ASIC may also be referred to as an application specific semiconductor, and unlike a standard semiconductor, which has a fixed specification and can be applied to any electronic product or application once certain requirements are satisfied, the application specific semiconductor is used for a specific product or function and is an integrated circuit manufactured by a semiconductor manufacturer according to a specific order. That is, the application specific semiconductor is designed and manufactured to perform only functions required for a specific device or a specific function, and the application specific semiconductor may be broadly classified, according to a design method, into a full custom IC in which circuits are designed and manufactured from the beginning according to user requirements, and a semicustom IC in which circuits are designed and manufactured by partially using standardized designs.

The application specific semiconductor is mainly used in communication systems, high-performance computing systems, consumer electronic products, automobiles, industrial automation, medical devices, military, aerospace industries, and the like, and has recently been applied to AI semiconductors that execute large-scale computation required for implementing AI with high performance and power efficiency.

The application specific semiconductor is used as a core component such as a network router, a switch, or a modem in the communication system, and performs data packet processing, protocol conversion, signal processing, and the like to provide high throughput and low latency. In the high-performance computing system, the ASIC is used as a core component for high-speed processing and parallel processing, and in the consumer electronic products such as digital cameras, smartphones, tablets, game consoles, and the like, the ASIC provides a high-performance and low-power solution required to perform a specific function. In the automotive industry, the ASIC is used to control various electronic systems inside an automobile, and in industrial automation systems, the ASIC provides a solution for high-precision control and high-performance processing.

The ASIC to which embodiments of the present invention are applied may include a memory in which an individual memory interface (I/F) is implemented, and may include a plurality of functional blocks that request memory access. Each functional block may be a direct memory access (DMA) functional block, a processor, a video processor, a cache controller, a decompression block, or a data path block. A basic configuration of the ASIC may include a transistor that amplifies or switches electrical signals, a logic gate which is a circuit combining transistors to perform a logical function, a memory cell that stores data, an analog circuit which is a circuit combining transistors to process a continuous voltage or current, and an intellectual property core (IP core) such as a microprocessor, a DSP, or a graphic core that is pre-designed to perform a specific function.

The ASIC may further include an individual memory interface (I/F) interfacing with an individual memory and an embedded memory interface (I/F) interfacing with an embedded memory, and the individual memory I/F may be connected to each functional block to receive memory access signals (e.g., control signals, address signals, and data signals) and generate signals for controlling the individual memory based on these input signals. The embedded memory I/F may be connected to each functional block to receive memory access signals (e.g., control signals, address signals, and data signals) and may generate modified memory access signals for controlling the embedded memory based on these input signals. The individual memory I/F and the embedded memory I/F may be designed in a memory control block of the ASIC to provide a memory control structure capable of being flexibly applied to both the individual memory and the embedded memory.

In addition, the ASIC for an artificial neural network (ANN) may include a plurality of neurons and a plurality of synapse circuits arranged in an array, each neuron including a register, a microprocessor, and at least one input, and each synapse circuit being configured to include a memory for storing synapse weights. Here, each neuron of the ASIC may be connected to at least one other neuron through one of the plurality of synapse circuits.

Although the present disclosure has been described as being generally implementable by a computing device, it will be understood by those skilled in the art that the present disclosure may be implemented in combination with computer-executable instructions and/or other program modules that can be executed on one or more computers, and/or by a combination of hardware and software.

Those skilled in the art to which the present disclosure pertains will understand that information and signals may be represented using any of a variety of different technologies and techniques. For example, data, commands, instructions, information, signals, bits, symbols, and chips that may be referred to in the above description may be represented by voltages, currents, electromagnetic waves, magnetic fields or particles, optical fields or particles, or any combination thereof.

Those skilled in the art to which the present disclosure pertains will understand that various exemplary logic blocks, modules, processors, means, circuits, and algorithm operations described in connection with the embodiments disclosed herein may be implemented by electronic hardware, various forms of programs or design codes (which are referred to herein, for convenience, as software), or a combination thereof. To clearly describe such interchangeability of hardware and software, various exemplary components, blocks, modules, circuits, and operations have been generally described above in relation to their functions. Whether such functions are implemented as hardware or software depends upon design constraints imposed on a specific application and an overall system. Those skilled in the art to which the present disclosure pertains can implement the functions described in various ways for each specific application, and such implementation decisions should not be interpreted as being outside the scope of the present disclosure.

The various embodiments suggested herein may be implemented as methods, apparatuses, or articles manufactured using standard programming and/or engineering techniques. The term “article manufactured” includes a computer program, a carrier, or a medium that can be accessed from any computer-readable storage device. For example, the computer-readable storage medium may include a magnetic storage device (e.g., a hard disk, a floppy disk, a magnetic strip, etc.), an optical disk (e.g., a CD, a DVD, etc.), a smart card, and a flash memory device (e.g., an EEPROM, a card, a stick, a key drive, etc.), but is not limited thereto. In addition, the various storage media described herein may include one or more devices and/or other machine-readable media for storing information.

It should be understood that the specific order or hierarchy of operations in the suggested processes are an example of exemplary approaches. Based on design priorities, it should be understood that the specific order or hierarchy of the operations in the processes may be rearranged within the scope of the present disclosure. The accompanying method claims provide elements of various operations in a sample order but are not meant to be limited to the suggested specific orders or hierarchies.

The description of the suggested embodiments is provided so that any person skilled in the art to which the present disclosure pertains may use or practice the present disclosure. Various modifications to these embodiments will be apparent to those skilled in the art to which the present disclosure pertains, and the general principles defined herein may be applied to other embodiments without departing from the scope of the present disclosure. Therefore, the present disclosure is not limited to the embodiments suggested herein, but should be construed in the widest scope consistent with the principles and novel features suggested herein.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A system comprising:
at least one processor; and
at least one memory storing an instruction or information executed by the at least one processor,
wherein an operation performed by the instruction or information executed by the at least one processor comprises:
an operation of extracting a graph embedding by inputting information relating to a material into a first artificial intelligence (AI) model;
an operation of extracting a text embedding by inputting a text description of a crystal structure of the material into a second AI model;
an operation of classifying the text embedding into a plurality of structure information embeddings; and
an operation of concatenating the graph embedding with at least one of the plurality of structure information embeddings,
wherein the structure information embeddings are classified to include global information, semi-global information, and local information of the crystal structure; and
an operation of determining details of at least one aspect of a crystal structure, a molecular structure, a protein structure, a catalyst structure, or a metal-organic framework (MOF) for the material, or a numerical representation for at least one physical property of the material, based on results of the concatenating operation.

2. The system of claim 1, wherein the first AI model comprises:
an embedding layer encoding a graph node for an atom of the crystal structure in the material information and connection information between the atoms; and
an interaction layer repeatedly refining a representation of the material based on the graph node and the connection information.

3. The system of claim 1, wherein
the global information comprises comprehensive arrangement information of the crystal structure including a mineral type, a space group, a dimensionality, and a symmetry property,
the semi-global information comprises atomic arrangement information in the crystal structure including geometry and connectivity in the crystal structure, and
the local information comprises atomic-level detailed information in the crystal structure including a type of the atom and a bond length between the atoms in the crystal structure.

4. The system of claim 1, wherein
the graph embedding is projected into a 128-dimensional vector through a first projection head of the first AI model,
the text embedding is projected into a 128-dimensional vector through a second projection head of the second AI model, and
the graph embedding and the text embedding are concatenated in a concatenate layer to generate a multimodal embedding.

5. The system of claim 4, wherein
the multimodal embedding is input into a fully connected layer to predict a property of a target material.

6. The system of claim 3, wherein
the graph embedding is concatenated with the text embedding including at least the semi-global information.

7. The system of claim 3, wherein
the graph embedding is concatenated with the text embedding including the global information and the semi-global information.

8. A method comprising:
extracting a graph embedding by inputting information relating to a target material into a first artificial intelligence (AI) model executed by a processor;
extracting a text embedding by inputting a text description of a crystal structure of the target material into a second AI model executed by the processor;
classifying the text embedding into a plurality of structure information embeddings by the processor; and
concatenating the graph embedding with at least one of the plurality of structure information embeddings by the processor,
wherein the structure information embeddings are classified to include global information, semi-global information, and local information of the crystal structure; and
predicting details of at least one aspect of a crystal structure, a molecular structure, a protein structure, a catalyst structure, or a metal-organic framework (MOF) for the target material, or a numerical representation for at least one physical property of the target material, based on results of the concatenating operation.

9. The method of claim 8, wherein, in the extracting of the graph embedding,
the material information input into the first AI model is encoded in an embedding layer as a graph node for an atom of a crystal structure in the material information and connection information between the atoms, and
a representation of the material is repeatedly refined in an interaction layer based on the graph node and the connection information.

10. The method of claim 8, wherein
the global information comprises comprehensive arrangement information of the crystal structure including a mineral type, a space group, a dimensionality, and a symmetry property,
the semi-global information comprises atomic arrangement information in the crystal structure including geometry and connectivity in the crystal structure, and
the local information comprises atomic-level detailed information in the crystal structure including a type of the atom and a bond length between the atoms in the crystal structure.

11. The method of claim 8, wherein, before the concatenating,
the graph embedding is projected into a 128-dimensional vector through a first projection head of the first AI model, and
the text embedding is projected into a 128-dimensional vector through a second projection head of the second AI model, and
in the concatenating,
the projected graph embedding and the projected text embedding are concatenated in a concatenate layer to generate a multimodal embedding.

12. The method of claim 11, wherein the predicting step comprises:
predicting a property of the target material,
wherein the predicting of the property comprises inputting the multimodal embedding into a fully connected layer to predict the property of the target material.

13. The method of claim 10, wherein, in the concatenating,
the graph embedding is concatenated with the text embedding including at least the semi-global information.

14. The method of claim 10, wherein, in the concatenating,
the graph embedding is concatenated with the text embedding including the global information and the semi-global information.

15. The method of claim 8, wherein the target material is a cathode material for a secondary battery, and wherein the predicting step predicts a shear modulus, a bulk modulus, or a bandgap of the target material.

16. The method of claim 15, wherein the target material comprises at least 60% manganese by weight.

17. An application specific integrated circuit (ASIC) comprising a functional block including a non-transitory memory storing information and an instruction and at least one processor requesting access to the memory,
wherein the memory stores an instruction or information for extracting a graph embedding by inputting information relating to a target material into a first artificial intelligence (AI) model, extracting a text embedding by inputting a text description of a crystal structure of the target material into a second AI model, classifying the text embedding into a plurality of structure information embeddings, and concatenating the graph embedding with at least one of the plurality of structure information embeddings,
wherein the structure information embeddings are classified to include global information, semi-global information, and local information of the crystal structure, and
wherein the memory stores a further instruction or information for generating a predicted numerical value for at least one physical property for the target material based on a result of the concatenating.

18. A system comprising:
at least one processor; and
at least one memory storing an instruction or information executed by the at least one processor,
wherein an operation performed by the instruction or information executed by the at least one processor comprises:
an operation of extracting a graph embedding by inputting information relating to a target material into a first artificial intelligence (AI) model;
an operation of extracting a text embedding by inputting a text description of a crystal structure of the target material into a second AI model;
an operation of performing cross-attention on the graph embedding and the text embedding; and
an operation of predicting a numerical value for at least one physical property for the target material based on a result of the cross-attention operation.

19. The system of claim 18, wherein the first AI model comprises:
an embedding layer encoding a graph node for an atom of the crystal structure in the target material information and connection information between the atoms; and
an interaction layer repeatedly refining a representation of the target material based on the graph node and the connection information.

20. The system of claim 18, wherein the text embedding comprises:
comprehensive arrangement information of the crystal structure of the target material;
atomic arrangement geometry information in the crystal structure; and
atomic-level detailed information in the crystal structure,
wherein the comprehensive arrangement information comprises a mineral type, a space group, a dimensionality, and a symmetry property; the atomic arrangement geometry information comprises geometry and connectivity in the crystal structure, and
the atomic-level detailed information comprises a type of the atom and a bond length between the atoms in the crystal structure.

21. The system of claim 18, wherein,
the cross-attention sets the graph embedding as a query and sets the text embedding as a key and a value to predict the query.

22. The system of claim 18, wherein the operation performed by the instruction or the information further comprises an operation of fine tuning the second AI model.

23. The system of claim 22, wherein,
the fine tuning is performed by a Low-Rank Adaptation (LoRA) method that freezes weights of the second AI model and reduces the number of trainable parameters.

24. A method comprising:
extracting a graph embedding by inputting information relating to a target material into a first artificial intelligence (AI) model executed by a processor;
extracting a text embedding by inputting a text description of a crystal structure of the target material into a second AI model executed by the processor;
performing cross-attention on the graph embedding and the text embedding by the processor; and
predicting a numerical value for at least one physical property for the target material based on a result of the performing step.

25. The method of claim 24, wherein, in the extracting of the graph embedding,
the material information input into the first AI model is encoded in an embedding layer as a graph node for an atom of a crystal structure in the material information and connection information between the atoms, and
a representation of the material is repeatedly refined in an interaction layer based on the graph node and the connection information.

26. The method of claim 24, wherein the text embedding comprises:
comprehensive arrangement information of the crystal structure of the material;
atomic arrangement geometry information in the crystal structure; and
atomic-level detailed information in the crystal structure,
wherein:
the comprehensive arrangement information comprises a mineral type, a space group, a dimensionality, and a symmetry property;
the atomic arrangement geometry information comprises geometry and connectivity in the crystal structure; and
the atomic-level detailed information comprises a type of the atom and a bond length between the atoms in the crystal structure.

27. The method of claim 24, wherein, in the performing of the cross-attention,
the graph embedding is set as a query and the text embedding is set as a key and a value such that the query refers to the key and the value to predict the query.

28. The method of claim 27, further comprising fine tuning the second AI model.

29. The method of claim 27, wherein, in the fine tuning,
the fine tuning is performed by a Low-Rank Adaptation (LoRA) method that freezes weights of the second AI model and reduces the number of trainable parameters.

30. The method of claim 24, wherein the target material is a cathode material for a secondary battery, and wherein the physical property predicted is a shear modulus, a bulk modulus, or a bandgap of the target material.

31. The method of claim 30, wherein the target material comprises at least 60% manganese by weight.

32. An application specific integrated circuit (ASIC) comprising a functional block including a non-transitory memory storing information and an instruction and at least one processor requesting access to the memory,
wherein the memory stores an instruction or information including operations of extracting a graph embedding by inputting material information into a first artificial intelligence (AI) model, extracting a text embedding by inputting a text description of a crystal structure of the material into a second AI model, performing cross-attention between the graph embedding and the text embedding, finetuning the second AI model, and predicting a property of a target material by inputting target material information into the first AI model.
